(19) United States
(12) Patent Application Publication
(10) Pub. No.: US 2016/0006643 A1
(43) Pub. Date: Jan. 7, 2016

(54) COMMUNICATION SYSTEM

(71) Applicant: NEC Corporation, Minato-Ku, Tokyo (JP)

(72) Inventor: MISAO FUKUDA, Tokyo (JP)

(21) Appl. No.: 14/764,276

(22) PCT Filed: Jan. 15, 2014
(86) PCT No.: PCT/JP2014/000146

§ 371 Date: Jul. 29, 2015

(30) Foreign Application Priority Data
Feb. 18, 2013 (JP) 2013-029236

(51) Int. Cl. H04L 12/751; H04L 12/803; H04L 12/703; H04L 12/717

(52) U.S. Cl. CPC H04L 45/02; H04L 45/42; H04L 47/122; H04L 45/28

(57) ABSTRACT

A communication system includes: a communication path instruction device which executes a communication path instruction process of giving an instruction to build a communication path in a given network to a network device installed in the network; the network device which builds the communication path in the network and processes given transmitted and received data, in response to the instruction by the communication path instruction device; and a control unit instructing another communication path instruction device different from the communication path instruction device to execute at least part of the communication path instruction process, at given timing.

### TECHNICAL FIELD

The present invention relates to a communication system. In particular, the present invention relates to a communication system which controls communication via a given network.

### BACKGROUND ART

The OpenFlow technology, which is a technology controlling communication between terminal devices via a network, has become known in recent years (see Patent Document 1, for example). A network based on the OpenFlow technology includes an OpenFlow controller and an OpenFlow switch. The OpenFlow controller sets a process of controlling a packet received by the OpenFlow switch, and notifies the set control process to the OpenFlow switch. The OpenFlow switch controls the packet on the basis of the control process notified by the OpenFlow controller.

For example, upon reception of a packet transmitted by a terminal device, the OpenFlow switch determines whether a control process appropriate for the received packet is preset. In a case where a control process appropriate for the received packet is preset, the OpenFlow switch executes the set control process. Consequently, the OpenFlow switch performs communication between terminal devices, for example.

On the other hand, in a case where a control process appropriate for the received packet is not set, the OpenFlow switch transmits the received packet to the OpenFlow controller. Then, the OpenFlow controller sets a control process appropriate for the received packet, and notifies the set control process to the OpenFlow switch. Consequently, the OpenFlow switch can execute a control process appropriate for the received packet, and performs communication between terminal devices, for example.

### Patent Document 1: Japanese Patent Application No. 2009-055739

For example, when using the OpenFlow technology stated above, each company or the like installs and manages a single OpenFlow controller in the company (for example, in a LAN (Local Area Network). Therefore, there is a problem that performing communication between terminal devices may be impossible when the OpenFlow controller becomes overloaded or when a failure occurs in the OpenFlow controller.

### SUMMARY

Accordingly, an object of the present invention is to provide a communication system which can solve the abovementioned problem, namely, the problem that performing communication between terminal devices may be impossible.

In order to achieve the object, a communication system as an aspect of the present invention includes:

a communication path instruction device executing a communication path instruction process, the communication path instruction process being a process of giving an instruction to build a communication path in a given network to a network device installed in the network;

the network device building the communication path in the network and processing given transmitted and received data, in response to the instruction by the communication path instruction device; and

a control unit instructing another communication path instruction device different from the communication path instruction device to execute at least part of the communication path instruction process, at given timing.

Further, a communication device as another aspect of the present invention includes:

a communication path instruction device executing a communication path instruction process, the communication path instruction process being a process of giving an instruction to build a communication path in a given network to a network device installed in the network; and

a control unit instructing another communication path instruction device different from the communication path instruction device to execute at least part of the communication path instruction process, at given timing.

Further, an information processing method as another aspect of the present invention includes:

executing a communication path instruction process by a communication path instruction device, the communication path instruction process being a process of giving an instruction to build a communication path in a given network to a network device installed in the network; and

instructing another communication path instruction device different from the communication path instruction device to execute at least part of the communication path instruction process, at given timing.

Further, a program as another aspect of the present invention is a computer program including instructions for causing a communication device to realize:

a communication path instruction device executing a communication path instruction process, the communication path instruction process being a process of giving an instruction to build a communication path in a given network to a network device installed in the network; and

a control unit instructing another communication path instruction device different from the communication path instruction device to execute at least part of the communication path instruction process, at given timing.

With the configurations as described above, the present invention enables secure communication between terminal devices.

### BRIEF DESCRIPTION OF DRAWINGS

FIG. 1 is a diagram showing the configuration of a communication system according to a first exemplary embodiment of the present invention;

FIG. 2 is a block diagram showing the function of an information processing unit according to the first exemplary embodiment of the present invention;

FIG. 3 is a block diagram showing the configuration of a virtual machine control part;

FIG. 4 is a block diagram showing the configuration of a terminal device;

FIG. 5 is a block diagram showing the configuration of an OpenFlow switch;

FIG. 6 is a diagram for describing a flow table;

FIG. 7 is a diagram showing the overview of a communication path;

FIG. 8 is a diagram for describing the overview of processing by the communication system;

FIG. 9 is a block diagram showing the configuration of a replication storage device;

FIG. 10 is a block diagram showing another example of the function of the information processing unit;

FIG. 11 is a sequence diagram showing the operation of the virtual machine control part;

FIG. 12 is a flowchart for describing a connection request process by the terminal device;

FIG. 13 is a flowchart for describing the operation of the OpenFlow switch;

FIG. 14 is a flowchart for describing a control process by an administrator function part;

FIG. 15 is a flowchart for describing an operation status determination process by the administrator function part;

FIG. 16 is a sequence diagram for describing an address solution process;

FIG. 17 is a sequence diagram for describing a network solution process;

FIG. 18 is a flowchart for describing a flow entry acquisition process by an OpenFlow controller function part;

FIG. 19 is a block diagram showing the function of an information processing unit according to a second exemplary embodiment of the present invention;

FIG. 20 is a diagram for describing the overview of processing by a communication system; and

FIG. 21 is a block diagram showing the function of an information processing unit according to a third exemplary embodiment of the present invention.

### EXEMPLARY EMBODIMENTS

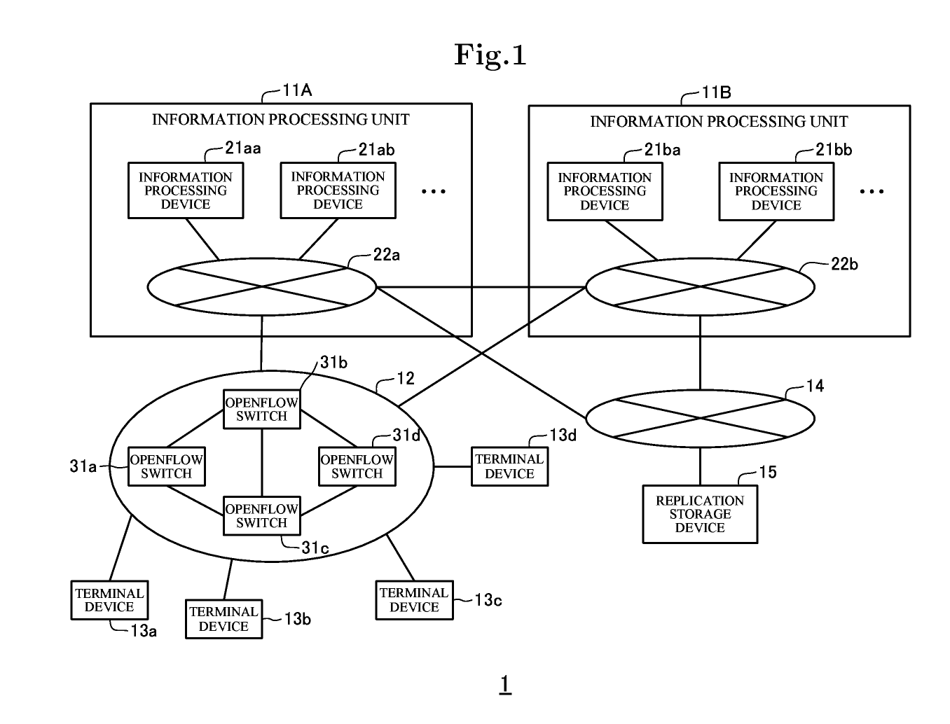

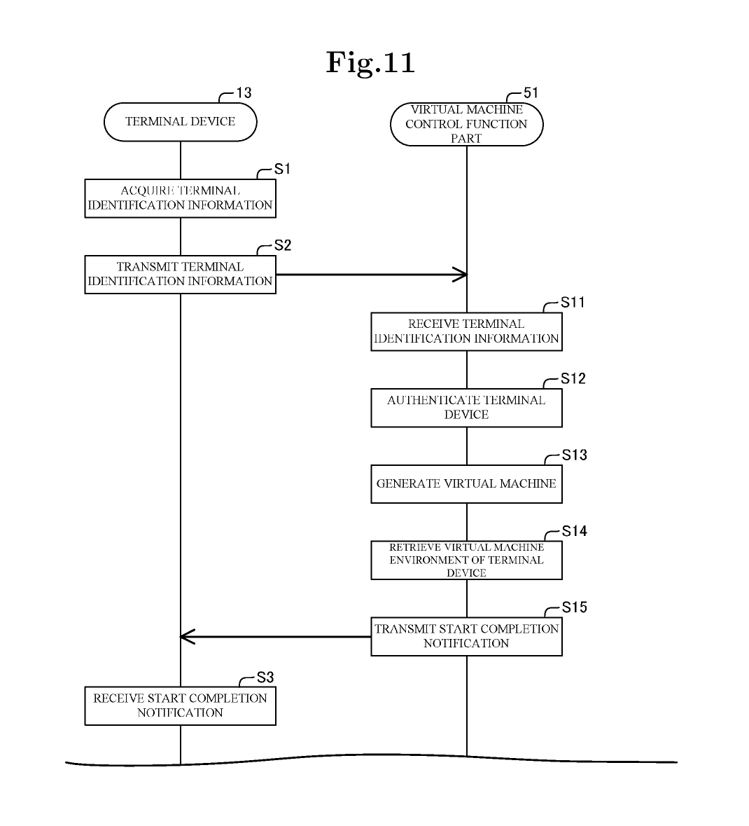

Below, an exemplary embodiment of a communication system according to the present invention will be described referring to FIGS. 1 to 18. FIGS. 1 to 10 are diagrams for describing the configuration of the communication system. FIGS. 11 to 18 are diagrams for describing the operation of the communication system.

### First Exemplary Embodiment

As shown in FIG. 1, a communication system 1 according to a first exemplary embodiment includes a plurality of information processing units 11 including information processing units 11A, 11B, . . . . For example, the information processing unit 11A is an information processing unit 11 located in a first country (for example, Japan), and the information processing unit 11B is an information processing unit 11 located in a second country (for example, the United States) different from the first country. It is needless to say that location is not limited to the abovementioned one and the information processing units 11 may be located in the same country. Moreover, the number of the information processing units 11 is not limited to two and the communication system 1 may include three or more information processing units.

The information processing unit 11A includes a plurality of information processing devices 21aa, 21ab, . . . (hereinafter, referred to as an information processing device 21 when not distinguished from each other. Other components will be described likewise). The information processing devices 21 are connected to each other so as to be capable of communicating via a network 22a in the information processing unit 11A. In this exemplary embodiment, each of the information processing devices 21 is configured by a blade server. Although the information processing unit 11A includes a plurality of information processing devices 21 herein, the information processing unit 11A may be configured by a single information processing device 21 (for example, the information processing device 21aa). That is to say, a single information processing device 21 may have a configuration to realize each function part of the information processing unit 11, which will be described later. Moreover, the other information processing unit 11B to be described below may also be configured by a single information processing device 21. A plurality of terminal devices 13a, 13b, . . . are connected to the network 22a in the information processing unit 11A, which is different from a network 12 (for example, a WAN (Wide Area Network)), via the network 12.

Likewise, the information processing unit 11B includes a plurality of information processing devices 21ba, 21bb, . . . . The information processing devices 21ba, 21bb, . . . are connected so as to be capable of communicating via a network 22b in the information processing unit 11B. That is to say, the information processing devices 21ba, 21bb, . . . included by the information processing unit 11B are located in a different network from the network where the information processing devices 21aa, 21ab, . . . of the information processing unit 11A are located. Although the information processing unit 11A will be described below, the information processing unit 11B also has the same configuration.

Each of the information processing devices 21 is configured to be capable of structuring a plurality of virtual machines (virtual servers). To be specific, each of the information processing devices 21 executes a program (a main OS) serving as a host OS (Operating System).

Further, each of the information processing devices 21 runs a virtual machine program that is a program for causing a virtual machine to operate, on the main OS. Furthermore, each of the information processing devices 21 runs at least one secondary OS (guest OS) on the virtual machine program.

In addition, each of the information processing devices 21 runs at least one application program on each of the guest OSs. The guest OS executed by each of the information processing devices 21 configures a virtual machine. Each virtual machine realizes one of function parts to be described later.

Each of a plurality of terminal devices 13 (terminal devices 13a, 13b, 13c, 13d, . . . in FIG. 1) is a personal computer, a smartphone or the like. Each of the terminal devices may be a mobile phone terminal, a PHS (Personal Handyphone System), a PDA (Personal Data Assistance, Personal Digital Assistant), a car navigation terminal, a game terminal, or the like.

The terminal devices 13 are connected so as to be capable of communicating via the network 12. The network 12 includes a plurality of OpenFlow switches 31 (network instruments) that can be connected to each other (referred to as the OpenFlow switch 31 hereinafter). The network 12 and the network 22a in the information processing unit 11A are different networks and are connected to each other. The networks 12 and 22 are each configured by a communication network such as an IP (Internet Protocol) network.

A replication storage device 15 stores replicated data that is a replication of data stored in the information processing unit 11, via a network 14. As replicated data is stored, even when data stored in the information processing unit 11 cannot be used, a given process can be executed by using the replicated data instead. The details of the replication storage device 15 will be described later.

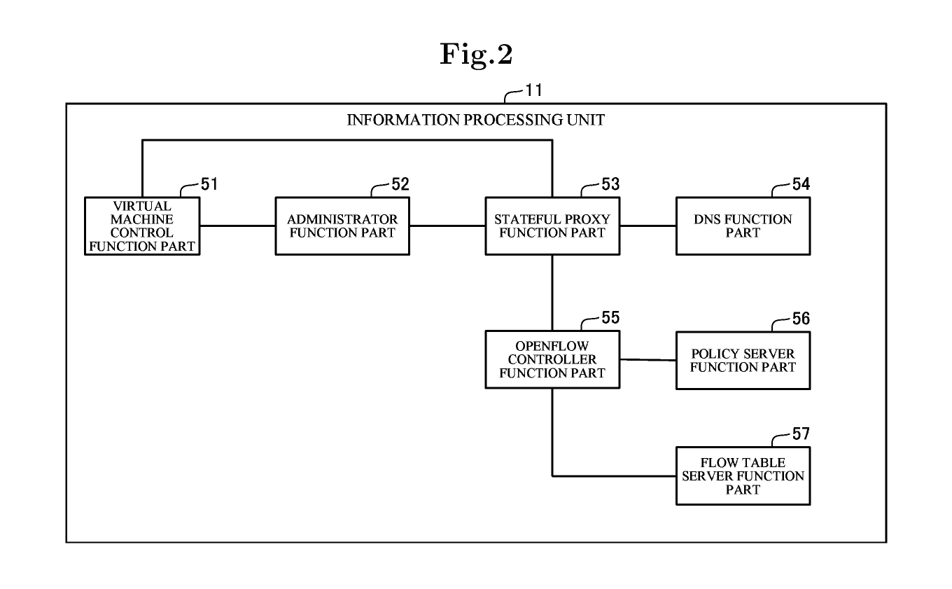

Next, the configuration of the information processing unit 11 will be described referring to FIG. 2. As shown in FIG. 2, the information processing unit 11 has a virtual machine control function part 51, an administrator function part 52 (a control unit), a stateful proxy function part 53, a DNS (Domain Name (Naming) System (Server)) function part 54, an OpenFlow controller function part 55 (a communication path instruction device) (referred to as the OpenFlow controller function part 55 hereinafter), a policy server function part 56 (the communication path instruction device), and a flow table server function part 57 (the communication path instruction device). Each of the function parts in the information processing unit 11 (for example, the OpenFlow controller function part 55) may be configured by a single information processing device 21, or may be configured by a plurality of information processing devices 21.

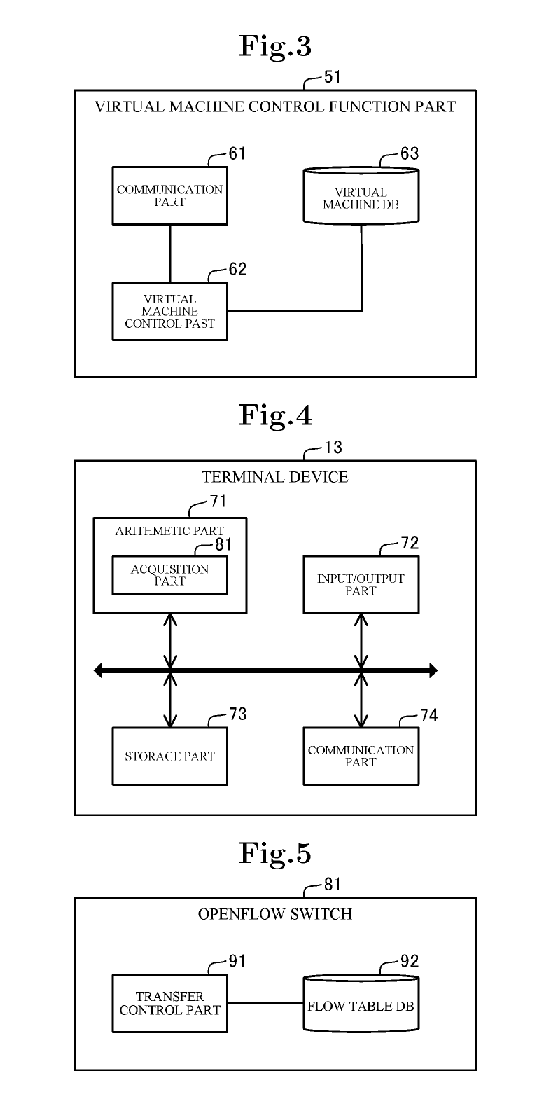

The virtual machine control function part 51 generates and controls a virtual machine in the information processing unit 11 and a virtual machine of the terminal device 13. FIG. 3 is a block diagram showing a detailed configuration of the virtual machine control function part 51. As shown in FIG. 3, the virtual machine control function part 51 includes a communication part 61, a virtual machine control part 62, and a virtual machine DB (Database) 63. Processing by the virtual machine control function part 51 will be described later.

The stateful proxy function part 53 and the DNS function part 54 are, for example, SIP (Session Initiation Protocol) servers, and control connection between user terminals. The OpenFlow controller function part 55, for example, designs a communication path in the network 12 and executes a communication path instruction process for instructing the OpenFlow switch 31 located in the network 12 to structure a communication path in the network 12. The policy server function part 56 stores policy information for setting a path in the network 12. The policy information will be described later. The flow table server function part 57 stores a flow table for instructing a path to the flow switch 31. The details of the respective function parts will be described in detail later.

Now a process executed when the terminal device 13 uses a virtual machine provided by the virtual machine control part 51 will be described. FIG. 4 is a block diagram showing the configuration of the terminal device 13. As shown in FIG. 4, the terminal device 13 includes an arithmetic part 71, an input/output part 72, a storage part 73, and a communication part 74. The arithmetic part 71 has a function of an acquisition part 81 by executing a program previously stored in the storage part 73. The terminal device 13 uses a thin client environment (for example, DaaS (Desktop as a Service) provided by the virtual machine control function part 51. Therefore, what the terminal device 13 needs to include is at least the arithmetic part 71 such as a CPU (Central Processing Unit), the input/output part 72, and the communication part 74.

First of all, the acquisition part 81 of the terminal device 13 acquires terminal identification information. Terminal identification information is information for authentication of a user or the like of the terminal device 13 by the virtual machine control function part 51, such as a user ID (Identification) and a password. For example, the terminal identification information may be input via the input/output part 72 by the user, or may be previously stored in the storage part 73. Subsequently, the communication part 74 of the terminal device 13 transmits the acquired terminal identification information to the virtual machine control function part 51 via the network 12.

Next, the communication part 61 of the virtual machine control function part 51 receives the terminal identification information transmitted from the terminal device 13. Subsequently, the virtual machine control part 62 of the virtual machine control function part 51 authenticates the terminal device 13 on the basis of the received terminal identification information. In a case where the authentication fails, a process of generating a virtual machine ends. In a case where the authentication succeeds, the virtual machine control part 62 generates a virtual machine. For example, the virtual machine control part 62 starts a program which controls a virtual machine, such as hypervisor, and generates a virtual machine.

Then, the virtual machine control part 62 retrieves a virtual machine environment of the terminal device 13 from the virtual machine DB 63. The virtual machine DB 63 stores a virtual OS, an application, terminal setting information, storage information and so on which are associated with a user ID, for example. Subsequently, the communication part 61 of the virtual machine control function part 51 transmits a start completion notification representing completion of start of a virtual machine to the terminal device 13. Then, the communication part 74 of the terminal device 13 receives the start completion notification. Consequently, the terminal device 13 can utilize a virtual machine

Next, referring to FIG. 5, the configuration of the OpenFlow switch 31 will be described. As shown in FIG. 5, the OpenFlow switch 31 includes a transfer control part 91 and a flow table DB 92. A flow table stored by the flow table DB 92 is information stored by execution of a preset communication path instruction process by the OpenFlow controller function part 55. The transfer control part 91 transfers packet information on the basis of the flow table stored by the flow table DB 92.

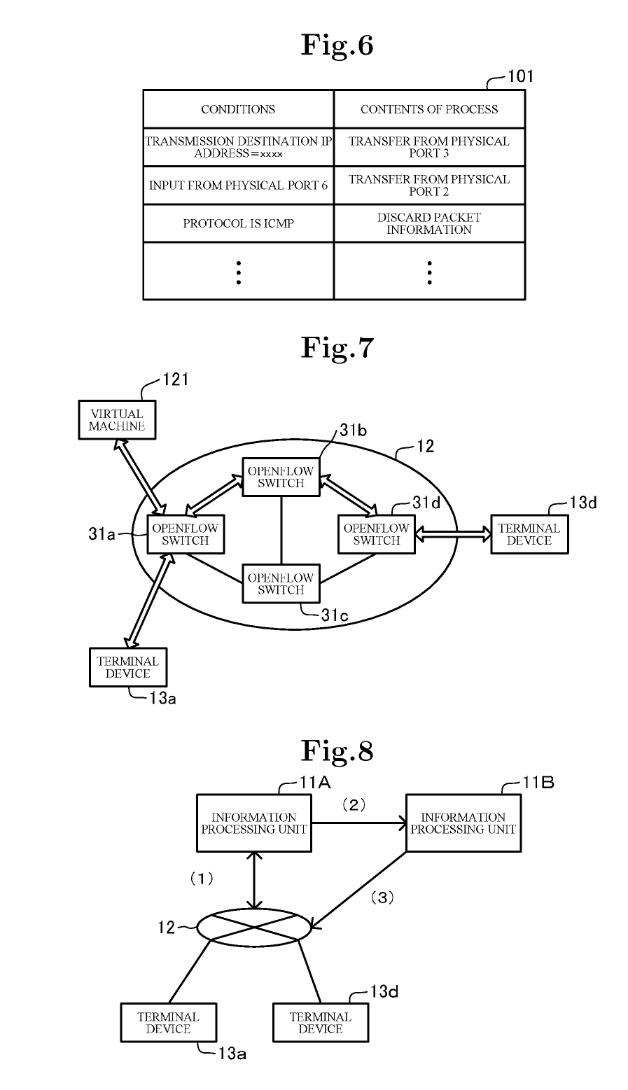

FIG. 6 is a diagram showing an example of a flow table 101 stored by the flow table DB 92. As shown in FIG. 6, the flow table 101 associates “condition” with “content of process.” Each row of the flow table 101 shows a flow entry. In the example shown in FIG. 6, when receiving packet information that a transmission destination IP address is “xxxx,” the transfer control part 91 transfers (transmits) the received packet information from a physical port 3. Moreover, when accepting input of packet information from a physical port 6 of the OpenFlow switch 31, the transfer control part 91 transfers the packet information from a physical port 2. Furthermore, when a protocol contained in received packet information is “ICMP (Internet Control Message Protocol),” the transfer control part 91 discards the received packet information. Because executing a transfer process based on each flow entry of the flow table 101, the transfer control part 91 can transfer packet information speedily and easily.

Processing executed when performing communication by using the OpenFlow switch 31 will be described. First, the acquisition part 91 of the terminal device 13 acquires communication source information and communication destination information. Communication source information includes, for example, the IP address, MAC address, port number and so on of the terminal device 13. Moreover, communication source information includes, for example, a company ID for identifying a company to which the user belongs, a section ID for identifying each section in the company, and so on. Communication source information may also include, for example, a group ID for identifying a company group which is a group of a plurality of companies. Communication destination information includes, for example, the telephone number of a communication destination when an IP phone is used, URL or the like when WEB is used, and the mail address of a communication destination when an e-mail is used.

Subsequently, the communication part 74 of the terminal device 13 transmits the acquired communication source information and communication destination information to the OpenFlow switch 31. Then, the transfer control part 91 of the OpenFlow switch 31 receives the communication source information and communication destination information transmitted from the terminal device 13. Subsequently, the transfer control part 91 determines whether or not a corresponding flow entry is stored. In other words, the transfer control part 91 determines whether or not information based on at least one of the received communication source information and the received communication destination information is included in “conditions” of flow entries stored in the flow table DB 92. In a case where a corresponding flow entry is stored, the transfer control part 91 executes a transfer process of transferring between the terminal device 13 and a terminal device 13 (a communication destination device) of the communication destination, in accordance with the content of the flow entry.

On the other hand, in the case of determining that a corresponding flow entry is not stored, the transfer control part 91 acquires topology information. Topology information is information representing the connection state of the OpenFlow switch 31. For example, topology information represents information of another OpenFlow switch 31, the terminal device 13 and so on connected to the respective ports of the OpenFlow switch 31. Subsequently, the transfer control part 91 acquires switch information. Switch information represents information of the flow table 101 stored in advance in the flow table DB 92 of the OpenFlow switch 31 or a flow table first set in the flow table DB 92.

Then, the transfer control part 91 transmits, as transfer setting information, the communication source information, the communication destination information, the topology information and the switch information to the administrator function part 52. Then, the administrator function part 52 receives the transfer setting information transmitted from the OpenFlow switch 31. Subsequently, the administrator function part 52 executes an operation status determination process. The operation status determination process is, for example, to determine whether or not congestion or failure has occurred in the information processing unit 11. The operation status determination process will be described later referring to FIG. 15.

In the case of determining that either congestion or failure has not occurred in the information processing unit 11, the administrator function part 52 instructs the stateful proxy function part 53 to execute an address solution process. In the address solution process, firstly, the stateful proxy function part 53 acquires (receives) the communication destination information from the administrator function part 52. In other words, the stateful proxy function part 53 extracts the communication destination information included in the transfer setting information received by the administrator function part 52.

Subsequently, the stateful proxy function part 53 outputs the acquired communication destination information to the DNS function part 54. Then, the DNS function part 54 acquires the communication destination information, and acquires a communication destination address (for example, an IP address) stored in association with the communication destination information. Subsequently, the DNS function part 54 outputs the acquired communication destination address to the stateful proxy function part 53.

Next, the stateful proxy function part 53 acquires the communication destination address transmitted by the DNS function part 54, and outputs the acquired communication destination address to the virtual machine control function part 51. Finally, the communication part 74 of the terminal device 13 receives the communication address transmitted from the stateful proxy function part 53 via a virtual machine. Thus, the terminal device 13 can acquire address information of the communication destination device.

Further, the administrator function part 52 instructs the stateful proxy function part 53 to execute a network solution process. The network solution process can be executed in parallel with the address solution process described above.

In the network solution process, firstly, the stateful proxy function part 53 acquires (receives) the transfer setting information from the administrator function part 52, and outputs the acquired transfer setting information to the OpenFlow controller function part 55.

Then, the OpenFlow controller function part 55 acquires the transfer setting information, and executes a flow entry acquisition process. In the flow entry acquisition process, firstly, the OpenFlow controller function part 55 determines whether or not a corresponding flow entry is stored. In other words, the OpenFlow controller function part 55 determines whether or not information based on at least one of the communication source information and the communication destination information included in the acquired transfer setting information is included in “conditions” of flow entries (for example, FIG. 6) stored in the flow table server function part 57.

In the case of determining that a corresponding flow entry is stored, the OpenFlow controller function part 55 acquires the flow entry stored in the flow table server function part 57. On the other hand, in the case of determining that a corresponding flow entry is not stored, the OpenFlow controller function part 55 acquires policy information. Policy information represents a rule for securing information security in an organization such as a company. For example, policy information includes information of connection destinations which can and/or cannot be communicated with, connection destinations which are preferentially connected to and so on, associated with the communication source information.

Subsequently, the OpenFlow controller function part 55 generates a flow entry. In other words, on the basis of the transfer setting information, the OpenFlow controller function part 55 sets a path between a communication source device and a communication destination device and sets “condition” and “content of process” for transferring packet information through the set path. Thus, the OpenFlow controller function part 55 designs a communication path in the network 12, for example. The OpenFlow controller function part 55 generates a flow entry corresponding to each of all the OpenFlow switches 31 in the network 12. Then, the OpenFlow controller function part 55 stores the generated flow entry into the flow table server function part 57, and also outputs the flow entry to the stateful proxy function part 53.

Then, the stateful proxy function part 53 acquires the flow entry output by the OpenFlow controller function part 55, and outputs the acquired flow entry to the OpenFlow switch 31 via the communication part 61 of the virtual machine control function part 51, for example. The stateful proxy function part 53 outputs corresponding flow entries to all the OpenFlow switches 31 in the network 12. Meanwhile, the stateful proxy function part 53 does not need to transmit any flow entry to an OpenFlow switch 31 whose corresponding flow entry does not exist.

Next, the transfer control part 91 of the OpenFlow switch 31 receives the output flow entry, and stores the received flow entry into the flow table DB 92. Thus, the OpenFlow switch 31 can execute a transfer process of transferring packet information between the terminal device 13 and the communication destination device, on the basis of the flow entry stored in the flow table DB 92.

Further, the OpenFlow switch 31 notifies a response to the terminal device 13. The response is information for notifying that transfer of packet information between the terminal device 13 and the communication destination device is enabled. Upon reception of the response, the communication part 74 of the terminal device 13 transmits given packet information to the OpenFlow switch 31. Thus, the terminal device 13 can transmit and receive packet information to and from the communication destination device.

For example, as shown in FIG. 7, in a case where the terminal device 13a performs communication with the terminal device 13d serving as the communication destination device, the user executes a given process on a virtual machine 121 and transmits given packet information from the terminal device 13a to the OpenFlow switch 31a. Then, the OpenFlow switch 31a refers to a flow table stored therein, and transfers the packet information received from the terminal device 13a to the OpenFlow switch 31b. Likewise, the OpenFlow switch 31b refers to a flow table stored therein, and transfers the packet information to the OpenFlow switch 31d. Then, the OpenFlow switch 31d directly communicating with the terminal device 31d refers to a flow table stored therein, and transfers the received packet information to the terminal device 13d. Thus, communication of given packet information between the terminal devices 13 is enabled.

When communication with the communication destination device ends, the terminal device 13 notifies end of communication to the administrator function part 52. Then, the OpenFlow controller function part 55 can reconfigure an OpenFlow table so as to optimize the flow table stored in the flow table server function part 52 and the flow tables stored in the respective OpenFlow switches 31. As a result, it is possible to prevent the flow tables from becoming too many.

Next, the operation status determination process by the administrator function part 52 will be described in detail. Firstly, the administrator function part 52 detects a load. The load represents a load on a preset function part among the function parts of the information processing unit 11. For example, the administrator function part 52 detects loads on the stateful proxy function part 53, the DNS function part 54 and the OpenFlow controller function part 55. Subsequently, the administrator function part 52 determines whether or not the acquired load is larger than a preset load threshold.

In the case of determining that the load is not larger than the threshold, the administrator function part 52 detects the presence/absence of a failure in the preset function part. Subsequently, in the case of determining that a failure has not occurred, the administrator function part 52 instructs the stateful proxy function part 53 to execute the address solution process and the network solution process as stated above.

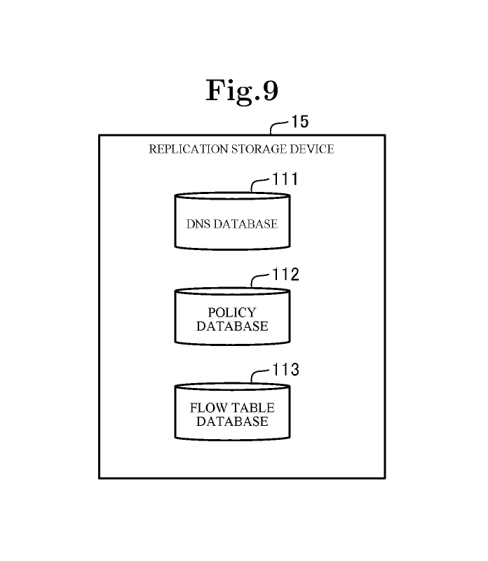

On the other hand, in the case of determining that a failure has occurred, or in the case of determining that the load is larger than the threshold, the administrator function part 52 designates the information processing unit 11B (another communication path instruction device located in a different network) that is different from the information processing unit 11A (in the network where the communication path instruction device is located), for example. Then, the administrator function part 52 instructs the designated information processing unit 11B (for example, the communication path instruction device) to execute the communication path instruction process (for example, (2) in FIG. 8). Consequently, the operation status determination process ends and, instead of the information processing unit 11 (for example, the administrator function part 52A of the information processing unit 11A), the other information processing unit 11 (for example, the administrator function part 52B of the information processing unit 11B) executes the communication path instruction process described above. Meanwhile, the administrator function part 52 does not necessarily need to instruct the other information processing unit 11B to execute the whole communication path instruction process, and may instruct the other information processing unit 11B to execute at least part of the communication path instruction process.

For example, the administrator function part 52B of the other information processing unit 11B receives the transfer setting information from the administrator function part 52A of the information processing unit 11A, and executes the operation status determination process on the information processing unit 11B. In a case where the administrator function part 52 monitors the operation status of another administrator function part 52 at all times and instructs another information processing unit 11 (for example, an information processing unit with the smallest load) in which congestion and/or failure has not occurred, the operation status determination process can be omitted.

Then, the administrator function part 52B instructs the stateful proxy function part 53B to execute the address solution process and the network solution process. In a case where the information processing unit 11B (the stateful proxy function part 53B) executes the address solution process, there is a case where the DNS function part 54B cannot acquire a communication destination address corresponding to the communication destination information. In such a case where the DNS function part 54B cannot acquire the communication destination address, the stateful proxy function part 53B outputs the communication destination information not to the DNS function part 54B but to a DNS database 111 of the replication storage device 15 shown in FIG. 9, and acquires the communication destination address. In a case where a terminal device 13x is located in a different network from the network 12 where the terminal device 13a is located, the stateful proxy function part 53A can output communication destination information not to the DNS function part 54A but to the DNS database 111 of the replication storage device 15 and acquire a communication destination address.

Likewise, when the information processing unit 11B executes the network solution process, there is a case where no policy information and no flow entry that correspond to the transfer setting information are not stored in the policy server function part 56B and the flow table server function part 57B, respectively. In such a case where the OpenFlow controller function part 55B cannot refer to the flow entry or acquire policy information, the OpenFlow controller function part 55B accesses, instead of the policy server function part 56B and the flow table server function part 57B, a policy database 112 and a flow table database 113 of the replication storage device 15 shown in FIG. 9, and acquires information for acquiring the flow entry. For example, when a terminal device 13x is located in a different network from the network 12 where the terminal device 13a is located, the OpenFlow controller function part 55A can access, instead of the policy server function part 56A and the flow table server function part 57A, the policy database 112 and the flow table database 113 of the replication storage device 15, and acquire information for acquiring a flow entry.

Thus, when the information processing unit 11A is normally operating, the information processing unit 11A executes a given communication path instruction process with a plurality of user terminals (for example, (1) in FIG. 8). On the other hand, the information processing unit 11A instructs the other information processing unit 11B to execute the communication path instruction process (for example, (2) in FIG. 8) at predetermined timing, and changes an information processing unit 11 to execute the communication path instruction process (for example, (2) in FIG. 8). Then, the other information processing unit executes a given communication path instruction process with the plurality of user terminals (for example (3) in FIG. 8). Therefore, even when a load on the OpenFlow controller function part 55 and so on becomes excessive, or even when a failure has occurred in the OpenFlow controller function part 55 and so on, it is possible to perform communication between the terminal devices 13.

The communication path instruction device (for example, the OpenFlow controller function part 55, the policy server function part 56, and the flow table server function part 57) may be configured by a plurality of information processing devices 21 each of which executes at least part of the communication path instruction process. Then, when the communication path instruction device cannot use part of the process (function), the administrator function part 52 instructs the other communication path instruction device to execute at least part of the communication path instruction process, which cannot be used.

For example, when the OpenFlow controller function part 55A of the information processing unit 11A causes congestion or failure and cannot be used, the administrator function part 52 instructs the OpenFlow controller function part 55B of the information processing unit 11B to execute at least part of the communication path instruction process instead of the OpenFlow controller function part 55A. Moreover, for example, when one of a plurality of information processing devices 21 configuring the OpenFlow controller function part 55A of the information processing unit 11A causes a failure or the like and cannot be used, the administrator function part 52 instructs an information processing device 21 having the same function as the abovementioned information processing device 21 and configuring the OpenFlow controller function part 55B of the information processing unit 11B to execute at least part of the communication path instruction process.

Furthermore, for example, when the policy server function part 56 of the information processing unit 11A causes congestion or failure and cannot be used, the administrator function part 52 accesses the policy database 112 of the replication storage device 15 storing a replication of the policy information stored in the policy server function part 56. Then, the administrator function part 52 instructs to execute at least part of the communication path instruction process instead of the policy server function part 56.

Thus, when part of the process of the communication path instruction device is unavailable (at given timing), the administrator function part 52 instructs another communication path instruction device which is capable of executing the unavailable function and is different from the above communication path instruction device to execute at least part of the communication path instruction process. As a result, even when congestion, failure or the like is caused in part of the communication path instruction device, it is possible to securely perform communication between the terminal devices 13.

The communication system 1 can instruct another information processing unit 11 to execute the communication path instruction process depending on the external situation of the communication system 1. Below, a case of changing an information processing unit 11 to execute the communication path instruction process depending on the external situation will be described. The information processing unit 11 shall include an external situation information acquisition part (not shown in the drawings) for acquiring external situation information. External situation information is, for example, information representing time in a place where the information processing unit 11 (itself) is installed, an external situation (for example, an accident or a disaster) which has occurred in the place where the information processing unit is installed, or an external situation (for example, an event) which may occur in the place where the information processing unit is installed. On the basis of the external situation information acquired by the external situation information acquisition part, the administrator function part 52 specifies another information processing unit 11 which is to instruct the communication path instruction process, and instructs the other information processing unit 11 having been specified to execute the communication path instruction process. Hereinafter, it will be described specifically.

The external situation information acquisition part acquires external situation information of a place where the information processing unit 11 (a given information processing device) is installed. For example, the external situation information acquisition part acquires current time in the place where the information processing unit 11 is installed, as external situation information. The external situation information acquisition part may acquire the current time by referring to a clock embedded in the information processing unit 11 itself, or may acquire the current time from a time server which provides time, or the like. Moreover, the external situation information acquisition part acquires position information representing the place where the information processing unit 11 is installed. For example, the position information of the information processing unit 11 shall be stored in advance. Then, the external situation information acquisition part shall acquire a given place in Japan as the position information and acquire the current time “12:00” as the external situation information. In this case, because the time “12:00” is in daytime (for example “9:00-17:00”), the administrator function part 52 acquires nighttime (for example, “0:00-5:00,” “21:00-23:00”) as the condition of the other information processing unit 11.

Then, the administrator function part 52 specifies another information processing unit 11 which agrees the acquired condition. To be specific, firstly, the administrator function part 52 specifies a place (a country) where it is nighttime when it is “12:00” in Japan, on the basis of information of time difference stored in advance. For example, the administrator function part 52 specifies “the United kingdom” where it is “3:00” when it is “12:00” in Japan. Thus, the administrator function part 52 specifies an information processing unit 11 located in “the United Kingdom” as the other information processing unit 11. Next, the administrator function part 52 refers to information processing unit information of “the United Kingdom” stored in advance, and acquires information such as an address for performing communication with the information processing unit 11 of “the United Kingdom.”

Then, on the basis of the acquired information processing unit information, the administrator function part 52 instructs the other information processing unit 11 having been specified to execute the communication path instruction process between the terminal devices 13. Because utilization of an information processing unit whose equipment is mostly free in nighttime is thus enabled, there is no need to invest in the equipment of the information processing unit 11, it is possible to reduce the cost of each of the information processing units 11, and it is possible to achieve increase of the utilization efficiency of the information processing unit 11.

Further, the external situation information acquisition part acquires time (external situation information) in a place where another information processing unit is installed at preset timing (for example, regularly). For example, the external situation information acquisition part acquires time in a place where another information processing unit 11 is installed, transmitted from the other information processing unit 11. In a case where the time in the place where the other information processing unit 11 is included in nighttime, the administrator function part 52 can instruct the other information processing unit 11 to execute the communication path instruction process.

Further, the administrator function part 52 can acquire the condition for another information processing unit 11 on the basis of a preset calculation criterion. For example, the administrator function part 52 adds (or subtracts) “12 hours” to (or from) the current time “12:00” acquired as the external situation information of the information processing unit 11, and acquires the calculated time “0:00” as the condition for another information processing unit. Then, the administrator function part 52 may specify an information processing unit installed in a place (a country) where the current time is “0:00” (for example, within a range of ±2 hours from the time “0:00”), as the other information processing unit.

Furthermore, external situation information acquired by the administrator function part 52 is not limited to time, and may be information of an event, a disaster and so on. For example, the external situation information acquisition part connects to an event management server which manages events and so on via the Internet or the like, and acquires and stores event information. When the external situation information acquisition part acquires the content of an event and the time and date of the event, the administrator function part 52 acquires, as the condition for another information processing unit 11, a condition that when the event is held in the place where the information processing unit 11 is installed (it is equivalent to information representing an instruction target situation), the event is not held in a place where the other information processing unit is installed. Subsequently, the administrator function part 52 determines whether or not the time and date of the event of the information processing unit 11 having been acquired coincides with the time and date of the event of the other information processing unit 11. In the case of determining that the times and dates of the event do not coincide, that is, in a case where the event is not held in the place where the other information processing unit 11 is installed when the event is held in the place where the information processing unit 11 is installed, the administrator function part 52 instructs the other information processing unit 11 to execute the communication path instruction process.

Next, a case of acquiring external situation information of an accident, an incident, a disaster and the like will be described. At given timing (for example, regularly), the external situation information acquisition part refers to URL (Uniform Resource Locator) stored in advance via the Internet or the like and a server device which provides information of an accident, an incident, a disaster and the like, and acquires external situation information of an accident, an incident, a disaster and the like having occurred in a place where an information processing unit 11 is installed. Alternatively, the external situation information acquisition part may use a device which detects a disaster, such as a seismometer, and acquire an external situation having occurred in a place where an information processing unit is installed.

Then, when the external situation information acquisition part acquires external situation information of an accident, an incident, a disaster or the like, the administrator function part 52 acquires, as the condition for another information processing unit 11, a condition that when an accident, an incident, a disaster and the like has occurred in the place where the information processing unit 11 is installed (it is equivalent to information representing an instruction target situation), an accident, an incident, a disaster or the like has not occurred in the place where the other information processing unit 11 is installed (or the external situation information of the other information processing unit has not been acquired).

Then, the administrator function part 52 determines whether or not the acquired condition is satisfied on the basis of the acquired external situation information of the information processing unit 11 and the external situation information of the other information processing unit 11. In other words, the administrator function part 52 determines whether or not an accident, an incident, a disaster or the like has occurred in the place where the other information processing unit 11 is installed when an accident, an incident, a disaster or the like has occurred in the place where the information processing unit 11 is installed. In a case where an accident, an incident, a disaster or the like has not occurred in the place where the other information processing unit 11 is installed, the administrator function part 52 instructs the other information processing unit to execute the communication path instruction process.

Thus, the administrator function part 52 instructs the other information processing unit 11 to execute the communication path instruction process, for example, in nighttime, when an event is to be held, or when a disaster or the like has occurred. As a result, it is possible to securely perform communication between the terminal devices 13.

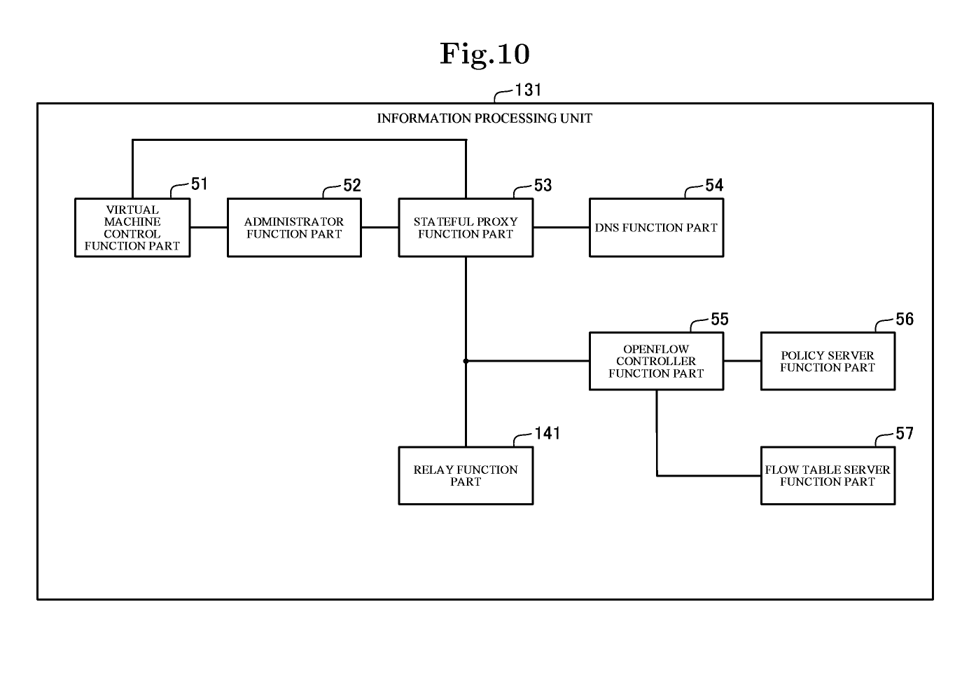

The information processing unit 11 of the communication system 1 may include a function for realizing UC (Unified Communication), for example. A case where the communication system includes the function for realizing UC will be described referring to FIG. 10.

As shown in FIG. 10, an information processing unit 131 is different from the information processing unit 11 shown in FIG. 2 in including a relay function part 141. Therefore, a description will be made focusing on the different point.

The relay function part 141 is, for example, a server for realizing UC. The relay function part 141 includes various communications and means of communication, and realizes efficient communication by integrating them. A means of communication is, for example, a WEB conference, a television conference, a multi-point conference, a chat, WR (Interactive Voice Response), a contact center, and so on.

Firstly, when using the function for UC, each of the terminal devices 13 transmits communication destination information including identification information of the relay function part 141 used by the terminal devices 13 to the information processing unit 131 (the administrator function part 52). Then, the stateful proxy function part 53 acquires the communication destination information of each of the terminal devices 13 via the administrator function part 52, and outputs the information to the DNS function part 54. Subsequently, the DNS function part 54 acquires a communication destination address based on the communication destination information, outputs the address to the stateful proxy function part 53. The stateful proxy function part 53 outputs the communication destination address to the relay function part 141.

Further, the stateful proxy function part 53 outputs transfer setting information to the OpenFlow controller function part 55. Then, the OpenFlow controller function part 55 executes the flow entry acquisition process, and generates a flow entry for connecting each of the terminal devices 13 with the relay function part 141. Subsequently, the stateful proxy function part 53 acquires the flow entry generated by the OpenFlow controller function part 55, and outputs the acquired flow entry to the OpenFlow switch 31 via the communication part 61 of the virtual machine control function part 51, for example. The stateful proxy function part 53 outputs corresponding flow entries to all the OpenFlow switches 31 in the network 12.

When receiving a response (notification of completion of network solution) from each of the terminal devices 13 via the OpenFlow switch 31, the relay function part 141 connects each of the terminal devices 13 on the basis of the communication destination address acquired from the stateful proxy function part 53. Then, the relay function part 141 provides the respective terminal devices 13 with means of communication selected by the terminal devices. Thus, the users of the terminal devices 13 can communicate given information between the terminal devices 13.

The administrator function part 52 may acquire at least one of load information representing a load on the relay function part 141 and occurrence of a failure in the relay function part 141, as an operation status. In a case where a load represented by acquired load information is larger than a predetermined threshold, or in a case where occurrence of a failure in the relay function part 141 is detected, the administrator function part 52 instructs another information processing unit 131 (a relay function part 141 included thereby) to relay the communication between the terminal devices 13. Consequently, it is possible to avoid occurrence of congestion or failure and perform communication between the terminal devices 13.

### (Operation)

Next, referring to FIGS. 11 to 18, the operation of the communication system 1 will be described. FIG. 11 is a sequence diagram for describing a process of generating a virtual machine.

First, the acquisition part 81 of the terminal device 13 acquires terminal identification information (step S1). Terminal identification information is information for the virtual machine control function part 51 to authenticate the user or the like of the terminal device 13, such as a user ID and a password. Terminal identification information may be input by the user via the input/output part 72, or may be stored in the storage part 73 in advance, for example.

Subsequently, the communication part 74 of the terminal device 13 transmits the terminal identification information acquired in the processing step S1 to the virtual machine control function part 51 via the network 12 (step S2). Next, the communication part 61 of the virtual machine control function part 51 receives the terminal identification information transmitted from the terminal device 13 in the processing step S2 (step S11).

Subsequently, the virtual machine control part 62 of the virtual machine control function part 51 authenticates the terminal device 13 on the basis of the terminal identification information received in the processing step S11 (step S12). In a case where the authentication fails, the process ends. Next, the virtual machine control part 62 generates a virtual machine (step S13). For example, the virtual machine control part 62 starts a program such as hypervisor, which is for controlling a virtual machine.

Then, the virtual machine control part 62 retrieves the virtual machine environment of the terminal device 13 from the virtual machine DB 63 (step S14). The virtual machine DB 63 stores, for example, a virtual OS, an application, setting information, storage information and so on which are associated with a user ID. Subsequently, the communication part 61 of the virtual machine control function part 51 transmits start completion notification showing completion of start of the virtual machine to the terminal device 13 (step S15). Then, the communication part 74 of the terminal device 13 receives the start completion notification (step S3). Thus, the terminal device 13 can use the virtual machine.

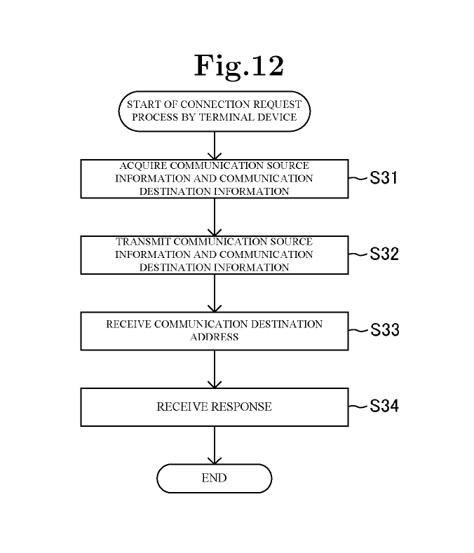

Next, referring to FIG. 12, a connection request process by the terminal device 13 will be described. First, the acquisition part 81 acquires communication source information and communication destination information (step S31). Communication source information includes the IP address, MAC address, port number and so on of the terminal device 13. Moreover, communication source information includes, for example, a company ID for identifying a company to which the user belongs, a section ID for identifying each section in the company, and so on. Communication source information may also include, for example, a group ID for identifying a company group which is a group of companies. Communication destination information includes, for example, the telephone number of a communication destination when an IP phone is used, URL or the like when WEB is used, and the mail address of a communication destination when an e-mail is used.

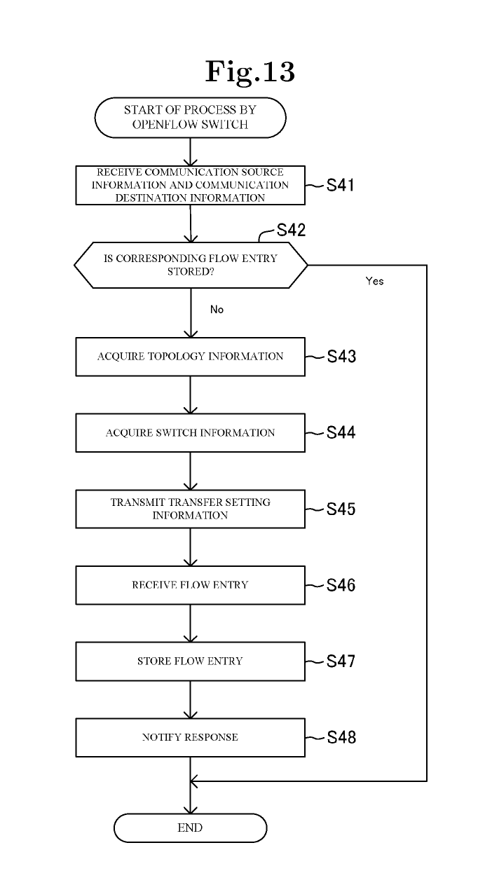

Subsequently, the communication part 74 transmits the communication source information and communication destination information acquired in the processing step S31 to the OpenFlow switch 31 (step S32). Next, referring to FIG. 13, the transfer control part 91 of the OpenFlow switch 31 receives the communication source information and communication destination information transmitted in the processing step S32 of FIG. 12 (step S41).

Subsequently, the transfer control part 91 determines whether or not a corresponding flow entry is stored (step S42). In other words, the transfer control part 91 determines whether or not information based on at least one of the communication source information and the communication destination information both received in the processing step S41 is included in “conditions” of flow entries stored in the flow table DB 92.

In the case of determining that a corresponding flow entry is not stored (step S42: No), the transfer control part 91 acquires topology information (step S43). Topology information is information representing the connection state of the OpenFlow switch 31. Topology information represents, for example, information of the other OpenFlow switch 31, the terminal device 13 and so on which are connected to the respective ports of the OpenFlow switch 31.

Subsequently, the transfer control part 91 acquires switch information (step S44). Switch information represents information of the flow table 101 stored in advance in the flow table DB 92 of the OpenFlow switch 31 or a flow table firstly set in the flow table DB 92. Then, the transfer control part 91 transmits, as transfer setting information, the communication source information, the communication destination information, the topology information and the switch information to the administrator function part 52 (step S45).

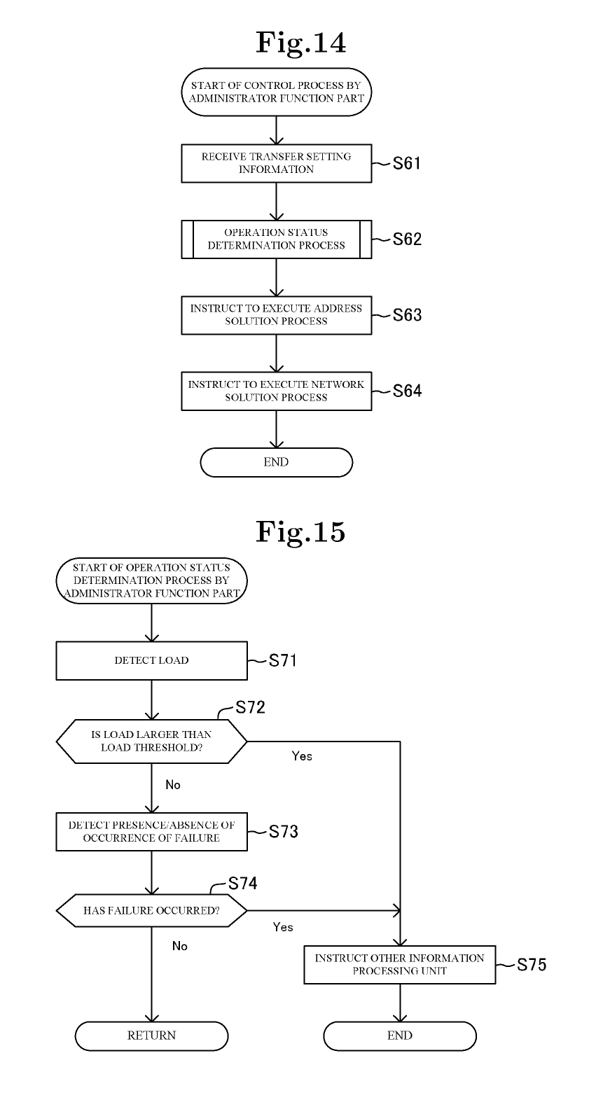

Next, referring to FIG. 14, a process by the administrator function part 52 will be described. The administrator function part 52 receives the transfer setting information transmitted from the OpenFlow switch 31 in the processing step S45 of FIG. 13 (step S61). Subsequently, the administrator function part 52 executes an operation status determination process (step S62). The operation status determination process is, for example, to determine whether or not congestion or failure has occurred in the information processing unit 11. The operation status determination process will be described later referring to FIG. 15.

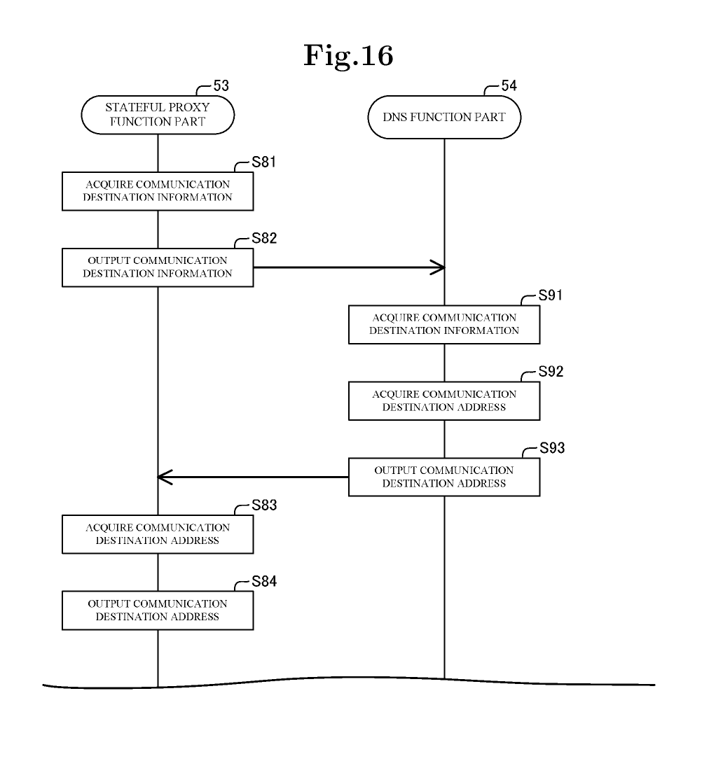

In the case of determining that congestion or failure has not occurred in the information processing unit 11, the administrator function part 52 instructs the stateful proxy function part 53 to execute an address solution process. Referring to FIG. 16, the address solution process will be described.

In the address solution process shown in FIG. 16, firstly, the stateful proxy function part 53 acquires (receives) the communication destination information from the administrator function part 52 (step S81). In other words, the stateful proxy function part 53 extracts the communication destination information included in the transfer setting information received by the administrator function part 52.

Subsequently, the stateful proxy function part 53 outputs the communication destination information acquired in the processing step S81 to the DNS function part 54 (step S82). Next, the DNS function part 54 acquires the communication destination information output in the processing step S82 (step S91). Then, the DNS function part 54 acquires a communication destination address (for example, an IP address) stored in association with the communication destination information (step S92). Then, the DNS function part 54 outputs the communication destination address acquired in the processing step S92 to the stateful proxy function part 53 (step S93).

Subsequently, the stateful proxy function part 53 acquires the communication destination address transmitted from the DNS function part 54 in the processing step S93 (step S83). Then, the stateful proxy function part 53 outputs the communication destination address acquired in the processing step S83 to the virtual machine control function part 51 (step S84).

Finally, the communication part 74 of the terminal device 13 receives the communication address transmitted from the stateful proxy function part 53 in the processing step S84 via the virtual machine (step S33 of FIG. 12). Thus, the terminal device can acquire address information of a communication destination device.

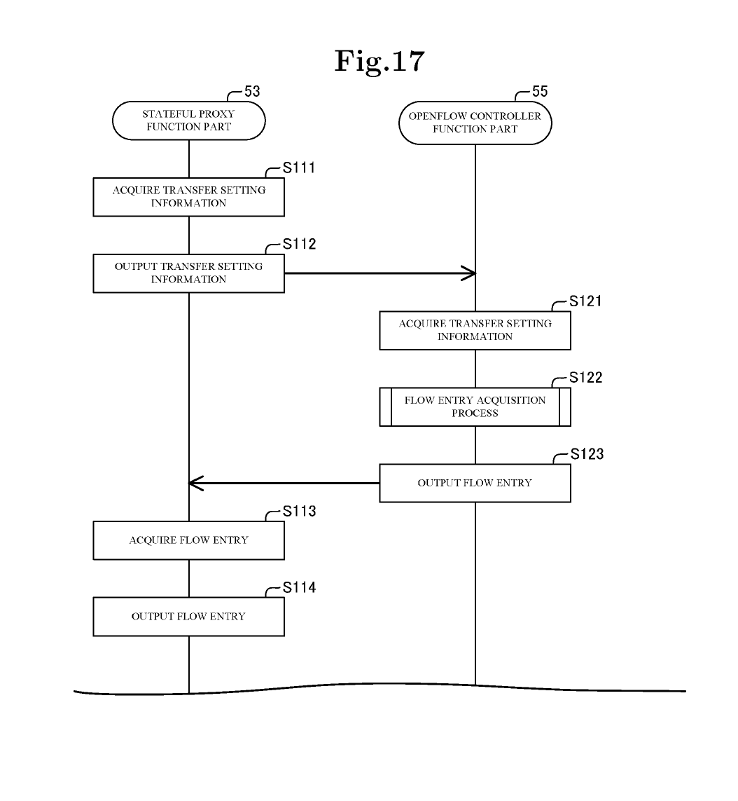

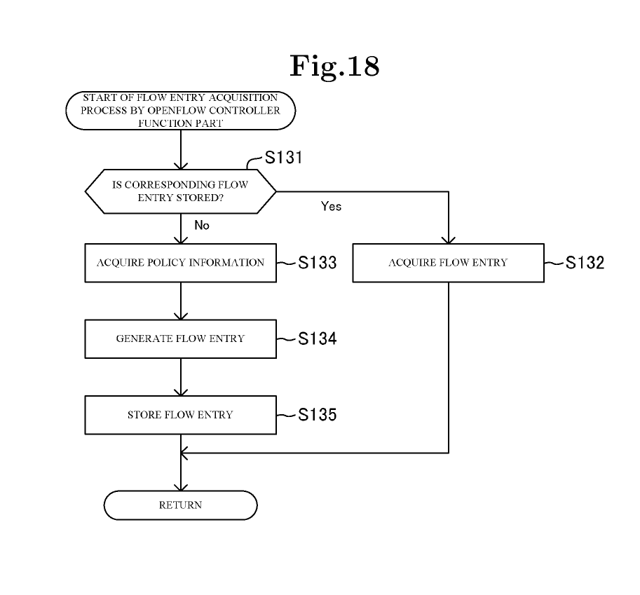

Further, at step S64 in FIG. 14, the administrator function part 52 instructs the stateful proxy function part 53 to execute a network solution process (step S64). Referring to FIGS. 17 and 18, the network solution process will be described. The network solution process can be executed in parallel with the address solution process shown in FIG. 16.

In the network solution process shown in FIG. 17, firstly, the stateful proxy function part 53 acquires (receives) the transfer setting information from the administrator function part 52 (step S111). Subsequently, the stateful proxy function part 53 outputs the transfer setting information received in the processing step S111 to the OpenFlow controller function part 55 (step S112).

Subsequently, the OpenFlow controller function part 55 acquires the transfer setting information output in the processing step S112 of FIG. 17 (step S121). Next, the OpenFlow controller function part 55 executes a flow entry acquisition process (step S122). Referring to FIG. 18, the flow entry acquisition process will be described.

In the flow entry acquisition process shown in FIG. 18, firstly, the OpenFlow controller function part 55 determines whether or not a corresponding flow entry is stored (step S131). In other words, the OpenFlow controller function part 55 determines whether or not information based on at least one of the communication source information and the communication destination information both included in the transfer setting information acquired in the processing step S121 is included in “conditions” of flow entries stored in the flow table server function part 57.

In the case of determining that a corresponding flow entry is stored (step S131: Yes), the OpenFlow controller function part 55 acquires the flow entry stored in the flow table server function part 57 (step S132). Then, the OpenFlow controller function part 55 omits processing steps S133 to S135 to be described below, and the process goes to step S123 of FIG. 17.

On the other hand, in the case of determining that a corresponding flow entry is not stored (step S131: No), the OpenFlow controller function part 55 acquires policy information (step S133). Policy information represents a rule for securing information security in an organization such as a company. Policy information includes, for example, information of connection destinations which can and/or cannot be communicated with, connection destinations which are preferentially connected to and so on, associated with the communication source information.

Subsequently, the OpenFlow controller function part 55 generates a flow entry (step S134). In other words, on the basis of the transfer setting information, the OpenFlow controller function part 55 sets a path between a communication source device and a communication destination device, and sets “condition” and “content of process” for transferring packet information on the set path.

Subsequently, the OpenFlow controller function part 55 stores the flow entry generated in the processing step S134 (step S135). After the processing step S135, the process goes to step S123 in FIG. 17. The OpenFlow controller function part 55 outputs the flow entry to the stateful proxy function part 53 (step S123).

Subsequently, the stateful proxy function part 53 acquires the flow entry output by the OpenFlow controller function part 55 in the processing step S123 (step S113). Then, the stateful proxy function part 53 outputs the flow entry acquired in the processing step S113 to the OpenFlow switch 31 via the communication part 61 of the virtual machine control function part 51 (step S114).

Next, at step S46 in FIG. 13, the transfer control part 91 of the OpenFlow switch 31 receives the flow entry output in the processing step S114 of FIG. 17 (step S46), and stores the received flow entry into the flow table DB 92 (step S47).

Subsequently, the OpenFlow switch 31 notifies a response to the terminal device 13 (step S48). This response is information for notifying that transfer of packet information between the terminal device and the communication destination device is enabled. After that, the OpenFlow switch 31 can execute a transfer process of transferring packet information between the terminal device 13 and the communication destination device on the basis of the flow entry stored in the flow table DB 92.

Subsequently, at step S34 in FIG. 12, the communication part 74 of the terminal device 13 receives the response notified in the processing step S48 of FIG. 13 (step S34). After the processing step S34, the connection request process by the terminal device 13 ends. After that, the terminal device 13 can transmit packet information including the communication destination address to the OpenFlow switch 31, thereby transmitting and receiving the packet information to and from the communication destination device.

Next, the operation status determination process shown in FIG. 15 will be described in detail. As shown in FIG. 15, firstly, the administrator function part 52 detects a load (step S71). This load represents a load on a preset function part among the function parts of the information processing unit 11. For example, the administrator function part 52 detects a load on at least one of the stateful proxy function part 53, the DNS function part 54, the OpenFlow controller function part 55, the policy server function part 56, and the flow table server function part 57. Subsequently, the administrator function part 52 determines whether or not the acquired load is larger than a preset load threshold.

In the case of determining that the load is not larger than the load threshold (step S72: No), the administrator function part 52 detects the presence/absence of a failure in the preset function part (step S73). In the case of determining that a failure has not occurred (step S74: No), the process goes to step S63 in FIG. 14, and the processing steps thereafter are repeated.

On the other hand, in the case of determining that a failure has occurred at step S74 (step S74: Yes), and in the case of determining that the load is larger than the load threshold at step S72 (step S72: Yes), the administrator function part 52 instructs another information processing unit (for example, the information processing unit 11B) to execute a communication path notification process (step S75). To be more specific, the administrator function part 52 instructs the other information processing unit to execute the address solution process and the network solution process. After the processing step S75, the operation status determination process ends, and the control process shown in FIG. 14 is again executed by the other information processing unit (for example, the administrator function part 52B of the information processing unit 11B).

For example, the administrator function part 52B of the other information processing unit 11B receives the transfer setting information from the administrator function part 52A of the information processing unit 11A (step S61), and executes the operation status determination process on the information processing unit 11B (step S62). Meanwhile, in a case where the administrator function part 52 monitors the operation status of the other administrator function part 52 at all times and instructs the other information processing unit 11 in which congestion and/or failure has not occurred (for example, an information processing unit with the smallest load), the operation status determination process at step S62 may be omitted.

Then, the administrator function part 52B instructs the stateful proxy function part 53B to execute the address solution process and the network solution process (steps S63 and S64). When the information processing unit 11B (the stateful proxy function part 53B) executes the address solution process, there is a case where the DNS function part 54B cannot acquire the communication destination address corresponding to the communication destination information. When the DNS function part 54B cannot acquire the communication destination address, the stateful proxy function part 53B outputs the communication destination information not to the DNS function part 54B but to the DNS database 111 of the replication storage device 15, and acquires the communication destination address.

Likewise, when the information processing unit 11B executes the network solution process, there is a case where the policy server function part 56B and the flow table server function part 57B store no policy information and no flow entry corresponding to the transfer setting information, respectively. In such a case where the OpenFlow controller function part 55B cannot refer to a flow entry and cannot acquire policy information, the OpenFlow controller function part 55B accesses, instead of the policy server function part 56B and the flow table server function part 57B, the policy database 112 and the flow table database 113 of the replication storage device 15, and acquires information for acquiring a flow entry.

Thus, even when use of the OpenFlow controller function part 55 and so on is difficult, it is possible to securely generate a flow entry and transmit the flow entry to the OpenFlow switch 31. As a result, it is possible to securely perform communication between terminal devices 13, for example.

### Second Exemplary Embodiment

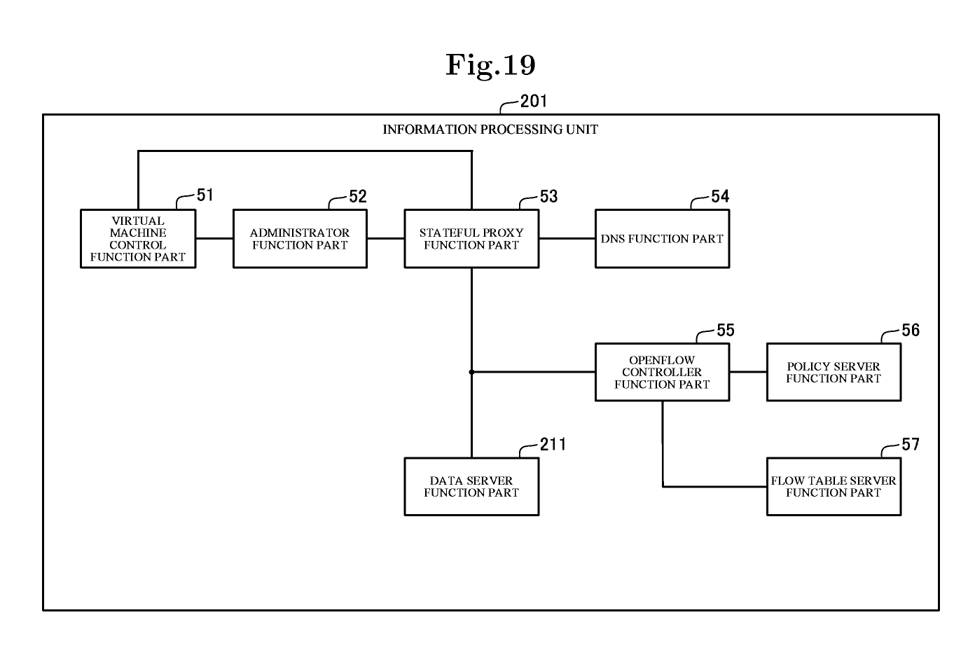

Next, a communication system according to a second exemplary embodiment of the present invention will be described. In an information processing system according to the second exemplary embodiment, as shown in FIG. 19, an information processing unit 201 has a data server function part 211 (a data storage device) for storing given data, unlike the information processing unit 11 in the first exemplary embodiment. Therefore, the different point will be described below.

The information processing unit 201 is used for technologies such as M2M (Machine-to-Machine or Machine-to-Management) technology, in which machines connected to a network mutually exchange information not via users and automatically executes optimum control, and ERP (Enterprise Resource Planning) technology, in which an enterprise as a whole manages every kind of management resources (manpower, physical assets, funds, and information) within the company in the integrated manner and allocates and distributes them in an optimum manner. When M2M technology is used, the data server function part 211 has a function of a machine server storing data transmitted from a machine serving as the terminal device 13. When ERP technology is used, the data server function part 211 has a function of an ERP server storing ERP data transmitted from the terminal device 13.

When the abovementioned technologies are used, the OpenFlow controller function part 55 of the information processing unit 201 generates a flow entry for connecting the terminal device 13 with the data server function part 211 on the basis of transfer setting information received from the administrator function part 52 via the terminal device 13 and the OpenFlow switch 31. For example, the OpenFlow controller function part 55 generates a flow entry for executing a given transfer process with the communication destination address of the data server function part 211 as a “condition.” Then, given data is transmitted from the terminal device 13 to the data server function part 211 and stored therein. The data stored in the data server function part 211 is sales information, stock information, and the like.

Then, when a person in charge who uses the data stored in the data server function part 211 requests for access to the data server function part 211 through the terminal device 13, the information processing unit 201 firstly executes the address solution process, and outputs the communication destination address of the data server function part 211 to the terminal device 13 held by the person in charge.

Subsequently, the terminal device 13 accesses the data server function part 211 via the OpenFlow switch 31 and the stateful proxy function part 53, and acquires the given data stored in the data server function part 211. Thus, it is possible to consolidate management of given information within the information processing unit 201 and, for example, it is possible to enable a person in charge to acquire the given information in any place.

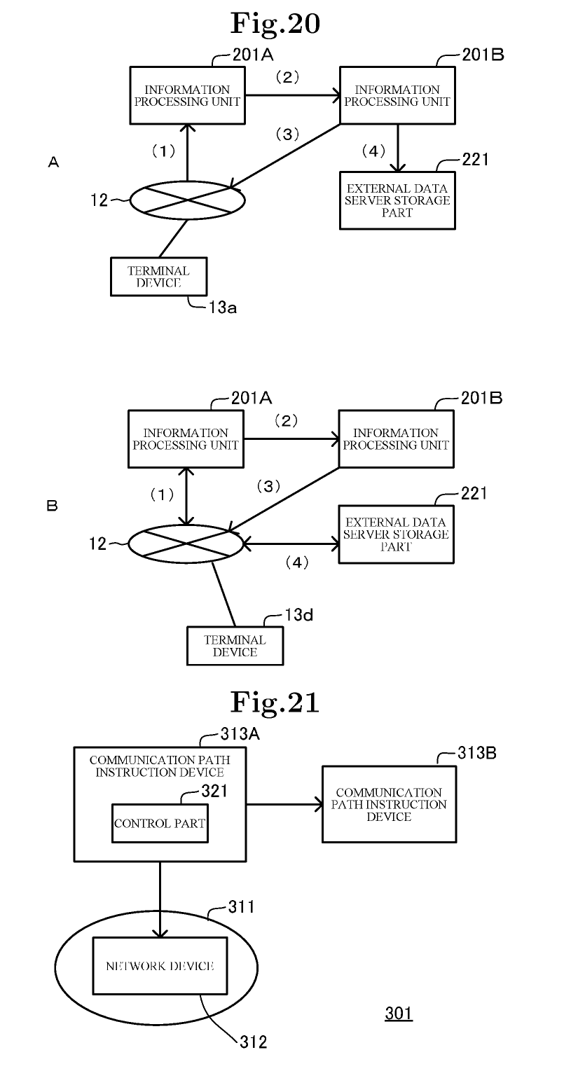

Meanwhile, for example, an information processing unit 201A can instruct another information processing unit 201B to execute the process described above. For example, the administrator function part 52A of the information processing unit 201A outputs transfer setting information acquired from the terminal device 13 to the administrator function part 52B of the information processing unit 201B at given timing ((2) in FIG. 20A). Then, the information processing unit 201B refers to the replication storage device 15 and executes the address solution process and the network solution process. The replication storage device 15 shall include an external data server storage part 221 (an external storage device) which stores replication of data stored in the data server function part 211 of the information processing unit 201A.

In other words, the other information processing unit 201B executes the address solution process and the network solution process, thereby generating a flow entry for connecting the terminal device 13 and the external data server storage part 221, and notifying to the OpenFlow switch 31 of the network 12 ((3) in FIG. 20A). Moreover, the other information processing unit 201B stores data output from the terminal device 13 into the external data server storage part 221 ((4) in FIG. 20A).

Then, when a person in charge or the like acquires the data stored in the external data server storage part 221, the information processing unit 201B acquires transfer setting information via the information processing unit 201A ((2) in FIG. 20B). Then, the information processing unit 201B executes the address solution process on the basis of the transfer setting information, and outputs the communication destination address of the data server function part 211 to the terminal device 13 held by the person in charge ((3) in FIG. 20B).

Subsequently, the terminal device 13 accesses the external data server storage part 221 via the OpenFlow switch 31, and acquires given data stored in the external data server storage part 221 ((4) in FIG. 20B). Accordingly, even when a load becomes too large in the information processing unit 201A, or even when a failure occurs in the information processing unit 201A, it is possible to store given data from the terminal device 13, and also securely retrieve the stored data.

### Third Exemplary Embodiment

Next, a communication system according to a third exemplary embodiment of the present invention will be described referring to FIG. 21.

A communication system 301 according to the third exemplary embodiment includes: a communication path instruction device 313A executing a communication path instruction process, the communication path instruction process being a process of giving an instruction to build a communication path in a given network 311 to a network device 312 installed in the network 311;

the network device 312 building the communication path in the network 311 and processes given transmitted and received data, in response to the instruction by the communication path instruction device 313A; and

a control part 321 (a control unit) instructing another communication path instruction device 313B different from the communication path instruction device 313A to execute at least part of the communication path instruction process, at given timing.

According to the above configuration, the communication path instruction device 313A executes a communication path instruction process of instructing the network device 312 placed in the given network 311 to build a communication path in the network 311. Then, in response to the instruction by the communication path instruction device 313A, the network device 312 builds a communication path in the network 311 and processes given transmitted and received data. Moreover, the control part 321 instructs the other communication path instruction device 313B different from the communication path instruction device 313A to execute at least part of the communication path instruction process. Therefore, for example, even when congestion or failure occurs and use of the communication path instruction device is difficult, the other communication path instruction device can give an instruction of a communication path to the network device. As a result, it is possible to securely perform communication between terminal devices, for example.

Although the present invention is described above referring to the exemplary embodiments, the present invention is not limited to the exemplary embodiments. The configurations and details of the present invention can be changed and modified in various manners that can be understood by one skilled in the art within the scope of the present invention.

### <Supplementary Notes>

The whole or part of the exemplary embodiments disclosed above can be described as, but not limited to, the following supplementary notes.

### (Supplementary Note 1)

A communication system comprising:

a communication path instruction device executing a communication path instruction process, the communication path instruction process being a process of giving an instruction to build a communication path in a given network to a network device installed in the network;

the network device building the communication path in the network and processing given transmitted and received data, in response to the instruction by the communication path instruction device; and

a control unit instructing another communication path instruction device different from the communication path instruction device to execute at least part of the communication path instruction process, at given timing.

According to the configuration described above, the communication path instruction device executes the communication path instruction process, which is a process of giving an instruction to build a communication path in a given network to a network device installed in the network. Then, the network device builds a communication path in the network and processes given transmitted and received data, in response to the instruction by the communication path instruction device. Moreover, the control unit instructs another communication path instruction device different from the communication path instruction device to execute at least part of the communication path instruction process, at given timing. Therefore, for example, even when congestion or failure occurs and use of the communication path instruction device is difficult, the other communication path instruction device can give an instruction of a communication path to the network device instead. As a result, it is possible to securely perform communication between terminal devices, for example.

### (Supplementary Note 2)

The communication system according to Supplementary Note 1, wherein the communication path instruction device and the control unit are installed in a different network from the network in which the network device is installed.

According to the configuration described above, the communication path instruction device and the control unit are placed in a different network from the network in which the network device is installed. Therefore, even when a failure or the like occurs in part of the network, it is possible to securely perform communication between terminal devices.

### (Supplementary Note 3)

The communication system according to Supplementary Note 1 or 2, wherein:

the communication path instruction device is configured by a plurality of information processing devices each executing at least part of the communication path instruction process; and

the control unit gives an instruction to execute at least part of the communication path instruction process executed by an information processing device of the information processing devices to another information processing device different from the information processing device, at given timing.

According to the configuration described above, the communication path instruction device is configured by a plurality of information processing devices each executing at least part of the communication path instruction process. Then, the control unit gives an instruction to execute at least part of the communication path instruction process executed by the information processing device to another information processing device different from the information processing device, at given timing. The communication path instruction process is thus configured by a plurality of information processing devices. Therefore, even when any of the information processing devices causes a failure or the like and cannot be used, it is possible to execute the communication path instruction process by using another information processing device instead.

### (Supplementary Note 4)

The communication system according to any one of Supplementary Notes 1 to 3, wherein the control unit detects a load on the communication path instruction device and, in a case where the detected load is larger than a preset threshold, instructs the other communication path instruction device to execute at least part of the communication path instruction process.

According to the configuration described above, the control unit detects a load on the communication path instruction device and, when the detected load is larger than a preset threshold, instructs another communication path instruction device to execute part of the communication path instruction process. Therefore, even when the communication path instruction device becomes overloaded and congestion or the like may occur, the other communication path instruction device executes at least part of the communication path instruction process. As a result, it is possible to avoid the congestion and securely perform communication between the terminal devices.

### (Supplementary Note 5)

The communication system according to any one of Supplementary Notes 1 to 4, wherein the control unit detects occurrence of a failure in the communication path instruction device and, in a case of detecting occurrence of a failure, instructs the other communication path instruction device to execute at least part of the communication path instruction process.

According to the configuration described above, the control unit detects occurrence of a failure in the communication path instruction device and, when detecting occurrence of a failure, instructs another communication path instruction device to execute at least part of the communication path instruction process. Therefore, even when a failure occurs in the communication path instruction device, the other communication path instruction device executes at least part of the communication path instruction process. As a result, it is possible to avoid the failure and securely perform communication between the terminal devices.

### (Supplementary Note 6)

The communication system according to any one of Supplementary Notes 1 to 5, wherein, on a basis of external status information representing preset external information of a place where the communication path instruction device is installed, the control unit instructs the other communication path instruction device to execute at least part of the communication path instruction process.

According to the configuration described above, on the basis of external status information representing preset external information of a place where the communication path instruction device is installed, the control unit instructs another communication path instruction device to execute at least part of the communication path instruction process. Therefore, it is possible to instruct the other communication path instruction device to execute at least part of the communication path instruction process, for example, at a time when a load on the communication instruction devices starts to get higher, and it is possible to efficiently perform communication between terminal devices.

### (Supplementary Note 7)

The communication system according to any one of Supplementary Notes 1 to 6, wherein the control unit designates, as the other communication path instruction device, a communication path instruction device installed in a different network from the network in which the communication path instruction device is installed, and instructs the designated other communication path instruction device to execute at least part of the communication path instruction process.

According to the configuration described above, the control unit designates, as another communication path instruction device, a communication path instruction device installed in a different network from the network in which the communication path instruction device is installed, and instructs the designated other communication path instruction device to execute at least part of the communication path instruction process. The other communication path instruction device installed in a different network from the network in which the communication path instruction device is installed is thus instructed to execute at least part of the communication path instruction process. Therefore, it is possible to avoid congestion, failure, or the like, and securely perform communication between terminal devices.

### (Supplementary Note 8)

The communication system according to any one of Supplementary Notes 1 to 7, comprising:

a data storage device storing given data transmitted from a terminal device; and

an external storage device storing replicated data obtained by replicating the data stored in the data storage device,

wherein, when receiving connection request information for connecting to the data storage device from the terminal device, the communication path instruction device generates communication path information so as to connect the terminal device to the external storage device and instructs the network device to build the communication path in the network in which the network device is installed, on a basis of the communication path information.

According to the configuration described above, the communication system includes a data storage device storing given data transmitted from a terminal device, and an external storage device storing replicated data obtained by replicating the data stored in the data storage device. Then, when receiving connection request information for connecting to the data storage device from the terminal device, another communication path instruction device generates communication path information so as to connect the terminal device to the external storage device and instructs the network device to build a communication path in the network in which the network device is installed, on the basis of the communication path information. Therefore, even when it is impossible to access the data storage device at given timing such as occurrence of congestion or failure, it is possible to access the external storage device. As a result, it is possible to acquire the same data as the data stored in the data storage device.

### (Supplementary Note 9)

A communication device comprising:

a communication path instruction device executing a communication path instruction process, the communication path instruction process being a process of giving an instruction to build a communication path in a given network to a network device installed in the network; and

a control unit instructing another communication path instruction device different from the communication path instruction device to execute at least part of the communication path instruction process, at given timing.

### (Supplementary Note 10)

An information processing method comprising:

executing a communication path instruction process by a communication path instruction device, the communication path instruction process being a process of giving an instruction to build a communication path in a given network to a network device installed in the network; and

instructing another communication path instruction device different from the communication path instruction device to execute at least part of the communication path instruction process, at given timing.

### (Supplementary Note 11)

A computer program comprising instructions for causing a communication device to realize:

a communication path instruction device executing a communication path instruction process, the communication path instruction process being a process of giving an instruction to build a communication path in a given network to a network device installed in the network; and

a control unit instructing another communication path instruction device different from the communication path instruction device to execute at least part of the communication path instruction process, at given timing.

The computer program disclosed in the exemplary embodiments and Supplementary Notes is stored in a storage device, or recorded on a computer-readable recording medium. For example, the recording medium is a portable medium such as a flexible disk, an optical disk, a magneto-optical disk and a semiconductor memory.

Although the present invention is described above referring to the exemplary embodiments, the present invention is not limited to the exemplary embodiments. The configurations and details of the present invention can be changed and modified in various manners that can be understood by one skilled in the art within the scope of the present invention.

The present invention is based upon and claims the benefit of priority from Japanese patent application No. 2013-029236, filed on Feb. 18, 2013, the disclosure of which is incorporated herein in its entirety by reference.

### DESCRIPTION OF NUMERALS

1 communication system
11 information processing unit
12 network
13 terminal device
14 network
15 replication storage device
21 information processing device
22 network
31 OpenFlow switch
51 virtual machine control function part
52 administrator function part
53 stateful proxy function part
54 DNS function part
55 OpenFlow controller function part
56 policy server function part
57 flow table server function part
61 communication part
62 virtual machine control part
63 virtual machine DB
71 arithmetic part
72 input/output part
73 storage part
74 communication part
81 acquisition part
91 transfer control part
92 flow table DB
111 DNS database
112 policy database
113 flow table database
131 information processing unit
141 relay function part
301 communication system
311 network device
312 network equipment
313A, 313B communication path instruction device
321 control part

What is claimed is:

1. A communication system comprising:
a communication path instruction device executing a communication path instruction process, the communication path instruction process being a process of giving an instruction to build a communication path in a given network to a network device installed in the network;
the network device building the communication path in the network and processing given transmitted and received data, in response to the instruction by the communication path instruction device; and
a control unit instructing another communication path instruction device different from the communication path instruction device to execute at least part of the communication path instruction process, at given timing.

2. The communication system according to claim 1, wherein the communication path instruction device and the control unit are installed in a different network from the network in which the network device is installed.

3. The communication system according to claim 1, wherein:
the communication path instruction device is configured by a plurality of information processing devices each executing at least part of the communication path instruction process; and
the control unit gives an instruction to execute at least part of the communication path instruction process executed by an information processing device of the information processing devices to another information processing device different from the information processing device, at given timing.

4. The communication system according to claim 1, wherein the control unit detects a load on the communication path instruction device and, in a case where the detected load is larger than a preset threshold, instructs the other communication path instruction device to execute at least part of the communication path instruction process.

5. The communication system according to claim 1, wherein the control unit detects occurrence of a failure in the communication path instruction device and, in a case of detecting occurrence of a failure, instructs the other communication path instruction device to execute at least part of the communication path instruction process.

6. The communication system according to claim 1, wherein, on a basis of external status information representing preset external information of a place where the communication path instruction device is installed, the control unit instructs the other communication path instruction device to execute at least part of the communication path instruction process.

7. The communication system according to claim 1, wherein the control unit designates, as the other communication path instruction device, a communication path instruction device installed in a different network from the network in which the communication path instruction device is installed, and instructs the designated other communication path instruction device to execute at least part of the communication path instruction process.

8. The communication system according to claim 1, comprising:
a data storage device storing given data transmitted from a terminal device; and
an external storage device storing replicated data obtained by replicating the data stored in the data storage device,
wherein, when receiving connection request information for connecting to the data storage device from the terminal device, the communication path instruction device generates communication path information so as to connect the terminal device to the external storage device and instructs the network device to build the communication path in the network in which the network device is installed, on a basis of the communication path information.

9. A communication device comprising:
a communication path instruction device executing a communication path instruction process, the communication path instruction process being a process of giving an instruction to build a communication path in a given network to a network device installed in the network; and
a control unit instructing another communication path instruction device different from the communication path instruction device to execute at least part of the communication path instruction process, at given timing.

10. An information processing method comprising:
executing a communication path instruction process by a communication path instruction device, the communication path instruction process being a process of giving an instruction to build a communication path in a given network to a network device installed in the network; and
instructing another communication path instruction device different from the communication path instruction device to execute at least part of the communication path instruction process, at given timing.

11. A non-transitory computer-readable medium storing a program comprising instructions for causing a communication device to realize:
a communication path instruction device executing a communication path instruction process, the communication path instruction process being a process of giving an instruction to build a communication path in a given network to a network device installed in the network; and
a control unit instructing another communication path instruction device different from the communication path instruction device to execute at least part of the communication path instruction process, at given timing.
